(19) United States
(12) Patent Application Publication
(10) Pub. No.: US 2018/0101919 A1
(43) Pub. Date: Apr. 12, 2018

(54) Land-use Sustainability Analysis Toolbox

(71) Applicant: Niveen Raafat Adib Ghattas, Frankfurt am Main (DE)

(72) Inventor: Niveen Raafat Adib Ghattas, Frankfurt am Main (DE)

(21) Appl. No.: 15/698,652

(22) Filed: Sep. 8, 2017

(30) Foreign Application Priority Data
Oct. 10, 2016 (DE) 10 2016 012 139.4

(51) Int. Cl. G06Q 50/16; G06Q 10/06

(52) U.S. Cl. CPC G06Q 50/165; G06Q 10/06313

(57) ABSTRACT

As there is an increasing need for tools, that evaluate the sustainability attainment in the land-use structure of neighborhoods in the field of the usage of the geographic information systems for the land use planning process support. The developed toolbox aims assessing the sustainability attainment in the land use structure of an urban neighborhood, through performing three main tasks, the services accessibility task for evaluating the residential parcels accessibility to the essential services within a neighborhood, based on the walking distance for the recreational, elementary schools, nurseries, and the commercial service for daily-needed products. As well as the time for the transfer to the residential parcels by vehicles, from the emergency services locations, represented in the fire and medical services.

The Land-uses sufficiency task for evaluating the sufficiency of the area of each land use type, for the needs of the study area's residents, as well as the identification of the areas required for the fulfillment of the residents' needs from the land-uses types, that have shortage. The Land—uses compatibility task for identifying the degree of compatibility between the neighboring land use types within the land use structure for a neighborhood, based on degree of the importance of locating each land use type near or away from other types.

The toolbox has been modeled within ArcGIS™ 10.3, using Python language, and adjusted according to the German standards, as default values, but in the same time, it can be easily readjusted by the users to any country standards.

### TECHNICAL FIELD

The usage of the geographic information systems as a tool for support the land use planning process.

### Research Problem

The research problem is represented in the need for computational tools to evaluate the sustainability attainment in the land-use structure of neighborhoods, so that the three sustainability dimensions can be assessed, in the way that the results can be easily understood by decision-makers, who may be not specialized in urban planning.

### Solution Suggested by the Invented Toolbox for the Research Problem

The toolbox presents three tasks for assessing the three dimensions of the sustainability in the land-use structure of neighborhoods, as will be later illustrated in details.

### The Technical Problem which the Toolbox Solves and the Means by which it is Solved

The technical problem solved by the toolbox is the lack of flexibility in many aspects in many computational tools used to support the land-use planning process, but the invented toolbox “Land-use Sustainability Analysis Tool-box” provides flexibility in the state of the evaluated land-use structure of the study area (existed or suggested state), the planning standards of the country in which the study area is located, the language of the data entry, and the input layers type in the ArcGIS™ (e.g. feature class or shape file).

### The Embodiment of the Toolbox (Description)

### Purpose of the Toolbox and the Main Concept Behind its Design

The purpose of the toolbox is assessing the sustainability attainment in the land use structure of a small urban area (neighborhood or small district) in a small or medium city, with regards to the sustainability attainment in this structure, as this area is supposed to include residential and mixed-residential-uses, as well as the minimum level from the required daily services uses, (the emergency services from medical & fire services, the recreational services, the daily-needed commercial service like food shops, and the pre-educational and primary educational services—i.e. nurseries & elementary schools).

So the main concept behind the toolbox's design is clarified in FIG. 1, which is represented in the data input for the land-use map (on the parcel level) and the roads network map, as well as the population data of the study area. And so the analysis or the evaluation of each of the land-use sufficiency, the accessibility to services, and the land uses compatibility, based on a predefined criteria, that are adjustable according to the country in which the study area is located.

Then taking an action for calculating and forming the analysis results, in the form of hot spot land-use map (for service accessibility and land use compatibility), and concise report (for land use sufficiency), as will be illustrated later in details.

### Notes:

“Land use sustainability analysis” toolbox is designed for dealing with simple roads network (i.e. pedestrians and vehicles roads), which is the most probable case for roads network in the small urban areas (neighborhood), as the target services can be accessed through the pedestrians and vehicles roads.
So this toolbox is not applicable in the case of complicated roads networks for the large cities, that includes several types of roads networks or transport modes (e.g. a Tram network, and under-ground network).
There are two main inputs layers for the “Land use sustainability analysis” toolbox, which are the land use shape file or feature class, and the roads network shape file or feature class. Both two layers should be a projected coordinate system (using distance units), and not as a geographic coordinate system (using a decimal degrees).

### The Main Tasks Performed by the Toolbox

The toolbox analyses the land-use structure sustainability, through performing three main tasks, which are task of the services accessibility evaluation, task of the land-use sufficiency evaluation, and task of the land-use compatibility analysis. Each task is responsible for one axis of the three sustainability axes:
The services accessibility task assesses the sustainability social dimension in the land-use structure, by evaluating to what extend the residential parcels have accessibility to the essential services within the neighborhood.
The Land-uses sufficiency task assesses the sustainability economic dimension, by evaluating the sufficiency of the area of each land use type for the needs of the neighborhood's residents.
The Land-uses compatibility task assesses the sustainability environmental dimension, by identifying the degree of compatibility between the neighboring land use types within the land use structure for the neighborhood, based on degree of the importance of locating each land use type near or away from other types.

### Development of the Toolbox

A group of script tools (*) are within that toolbox, that have been developed using the Python language, to work through the software ArcGIS™ 10.3, (FIG. 2), and adjusted according to the German standards, as default values, but in the same time, it can be easily re-adjusted by the users to any country standards.

(*) ‘Script Tool’ is an ArcGIS™ structure within a custom toolbox, which works through a Python script (Tateosian, 2015, p. 449)

### Requirements Needed for the Toolbox

Advanced ArcGIS™ 1.0.3 version
Network Analyst Extension

### Guide for Each Task

### The Services Accessibility Task

This task is responsible on assessing the social dimension of the sustainability attainment in the land-use—structure for neighborhoods. This task is different than the other two tasks, as there are three steps done within this task, the first and the third steps are done by script tools within the toolbox, however, the second step is done manually by the user, as illustrated below.

First. Data Preparation Step/Tool (FIG. 3)
Helps greatly the users, who do not have big background or knowledge in the network analyst extension.
In this step, the roads shape file or feature class is prepared for the building of the network analysis datasets in the next step, by preparing a roads feature dataset that includes two features classes (FIG. 4):
   The first is a feature class for vehicles roads (i.e. all the roads excluding the pedestrian roads or roads that cannot be accessed by vehicles), in order to build a network analysis dataset specialized for evaluating the accessibility to services via vehicles, based on this vehicles road feature class.
   The second is a feature class for all roads (i.e. all the roads including the pedestrian roads or roads that can be accessed by walking), in order to build another network analysis dataset specialized for evaluating the accessibility to services via walking, based on this comprehensive road feature class.
Then checking the presence of the important fields, that should be in the roads feature classes for building the previously mentioned two network analysis datasets. And so, adding the required fields for this purpose, with the appropriate names for these fields and data format, for the analysis process using the services accessibility tools in the third step.

Second. Building the Network Analysis Datasets (the Only Step Done Manually by the User)
Despite building the Network analysis Dataset is an easy step, however, it should be done manually by the user, because it cannot be scripted or programmed within a tool in Arcmap™ software.
As a Network analysis dataset is one of the input parameters in any tool of the six services accessibility tools, so building an appropriate Network analysis Dataset is the preliminary step, before going to any of these six services accessibility tools.
In this step, the user builds two Network analysis Datasets:
   The first is based on the vehicles roads feature class (for assessing services, that are accessed by vehicles—emergency services).
   The second is based on the comprehensive roads feature class for both vehicles and non-vehicles roads, (for assessing services, that are accessed by walking).

Third. Services Accessibility Step/Tool (FIG. 5)
The main concept behind the design of this step is finding the routes for the closest services, and so analyzing these routes, to find how far, or how much time required for transferring from the residential parcels to the closest facility parcel in some services types, or vice versa for other services types, which is the degree of the residential parcels' accessibility to services.
The analysis of the routes depends (in some services) on the length of these routes in meters as “a cost attribute”, from the residential parcels to these services, (e.g. the primary educational service). Whereas for the other services, the analysis of the routes depends on the time taken in minutes by vehicles “as a cost attribute” in these routes from these services to the residential parcels, these services are the emergency services.
Example, the degree of accessibility to the primary educational services (the elementary schools), according to the German standards, is identified by the distance, that the elementary schools' pupil should not walk more than it, which is called “cutoff value”, so:
   If the distance of the route between a residential parcel to the elementary school parcel is less or equal to 700 meters, (Schoening et al., 1992, p. 52), then this residential parcel is totally accessible to the elementary school parcel.
   If it is more than 700, but less or equal to 1000 meters, then this residential parcel is partially accessible to the elementary school parcel.
   If it is more than 1000 meters, then this residential parcel is not accessible the elementary school parcel (FIG. 6).

### The Land Use Sufficiency Task/Tool (FIG. 7)

The main concept of this tool is calculating the available areas from the required essential land uses types for any neighborhood, and comparing these available areas with the needs of the population in the study area, and so finding whether there is a shortage in any land use type, or not.
So, if there is a shortage, the tool calculates the required area recommended, to be added to fulfill the population needs from the land use type, which has that shortage (FIG. 8).
The main input for this tool is the land use layer, which should be with a projected coordinate system.

### The Land Use Compatibility Task/Tool (FIG. 9)

Before stating the main concept of the land-use compatibility task in the toolbox, it is important to state, that this task requires the direct attachment between polygons representing the land lots, either through a common edge or node, so this tool is applicable on the land use layer, that includes attached ownership limits of each land use type in each land lot, as shown in FIG. 10

That means that in case that two land parcels are not attached or separated by a street or any space, the relations among their land use types cannot be assessed by the land use compatibility tool, as this tool can only deal with the direct attached land parcels.
The main concept of this tool is based on identifying the compatibility degree, resulted from the neighboring between each two different land use types, these two neighboring land uses may have a common edge, or have a common node or vertex (FIG. 11).
So the common edge or node will have a value, which is the assessment of the compatibility degree between the two different neighboring polygons, that are occupied by these two land uses types. The compatibility degree values are divided into three ranges, the highest range is for the highly or totally compatible land uses, the moderate is for the partially compatible land uses, and the lowest is for the not compatible land uses.
The compatibility degree means to what extent the existence of any two land use beside each other, is beneficial and positively effective, and there is no conflict between them, based on degree of the importance of locating each land use type near or away from other types (AMINDE et al., 2010, p. 114)

### The Advantages in the Toolbox

There are general advantages, which are common in the three tasks performed by the toolbox, in addition to definite advantages in each task of them:

### General Advantages

Results can be easily understood by unspecialized people.
Can be applied on current or suggested land use structure.
Flexible to any language of the data entry.
Flexible to any country circumstance standards.
Check the appropriateness of the coordinate system of the entered feature class or shape file, as it should be a projected coordinate system (with length units), not a geographic coordinate system (with degrees units), in order to have values in the shape length and shape areas fields.
Flexibility in the layer type of the input land use layer (as a feature class or shape file) for the tools (land use sufficiency, land use compatibility, & services accessibility).
Also the flexibility in the layer type of the input roads layer (as a feature class or shape file) for the data preparation tool, but for the services accessibility tools, it should be one of the two feature classes, which are within the feature dataset, that is prepared by the data preparation tool, before using it as an input in the services accessibility tools.

### Advantages in the Services Accessibility Task

Help those who are not expert with Network Analysis extension, by preparing a roads feature dataset, that includes two roads feature classes, with the required fields for building the network analysis datasets, through the data preparation tool, before check the service accessibility. So after the data preparation tool, the user should only build the network analysis datasets.
Then, the services accessibility tools will complete the task, so the user will not have to choose the suitable type of the network layer, according to the type of service, (e.g. closest facility, best route, service area, . . . etc.).
The data preparation tool considers both the vehicles roads and non-vehicles roads (or pedestrian roads), and separates the vehicles roads in an independent feature class within the output roads feature dataset, to avoid any unrealistic results, to confirm that the routes, that are suggested to access services using vehicles, are based on vehicles roads.
Also the data preparation tool considers the directions of the vehicles roads, whether they are one-way streets or two-ways streets, and also the roads degree (if its data is given by the user).
The services accessibility tools can be flexibly applied on any other service types, like post offices or gas stations.

### Advantages in the Land-Use Sufficiency Task

Not only evaluates the sufficiency of each land use type, but also, identifies the required area, that needed to be added from each land use type, in order to fulfill the population's needs.
Flexible for the presence or the absence of any type of land use types, that can be found and required in a neighborhood within a small or medium city.
There is no need for identifying the number of floors in each land lot for calculating the sufficiency of each land use type, as the default standards in the land use sufficiency tool, are based on the land area, so do not require considering number of floors.
Flexible for the presence or the absence of the data regarding various age categories population for the residents of the study area, (the number of residents in the age of the nursery service or the primary education service), as sometimes this type of data is not available for the user. So in this case the tool is already provided by default values for the minimum required area from each type of these two services, with regards to the whole population of the study area (according to the German standards), also these default values can be easily re-adjusted by the user to any standards of any country.

### Advantages in the Land-Use Compatibility Task

Can deal with mixed uses in the land use structure, according to the user vision, as the user can consider the use of the multi-use land parcel:
   As definite type of land use, that is proposed to evaluation.
   Or as the dominant type in the multi-use parcel.
   Or as a mixed use or multi-use in general.
It allows the user to consider any type of land uses in any category, according to the planning concepts of the country, in which the study area is located, (e.g. the cafes can be considered as social activities in one country, and as cultural in other country, or as commercial or as recreational, and so on), so the user will select the category of each land use type, according to his/her vision.
Flexible for the presence or the absence of any type of land use types, that can be found in a neighborhood within a small or medium city. Moreover, considers the probability of the presence of undesired or polluting land use types.

### FIGURES DESCRIPTIONS

FIG. 1 shows the main concept behind the toolbox's design.

FIG. 2 shows the script tools within the toolbox.

FIG. 3 shows the dialogue window of the data preparation tool

FIG. 4 shows the outputs of the data preparation tool (roads feature dataset and the attribute table in the feature classes within this dataset)

FIG. 5 shows the dialogue window of the service accessibility tool

FIG. 6 shows an example for the output map of the service accessibility tool

FIG. 7 shows the dialogue window of the land use sufficiency tool

FIG. 8 shows an example for the output results (concise report) of the land use sufficiency tool

FIG. 9 shows the dialogue window of the land use compatibility tool

FIG. 10 shows the attached ownership limits of the land lots that can be evaluated by the land use compatibility tool

FIG. 11 shows an example for the output map of the land use compatibility tool

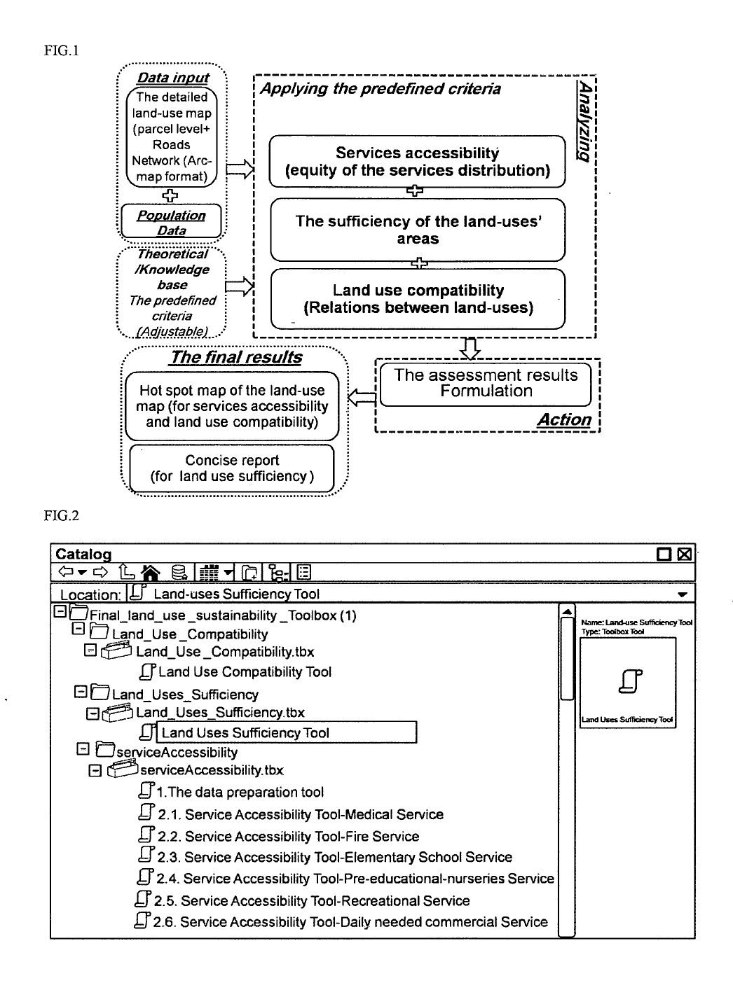

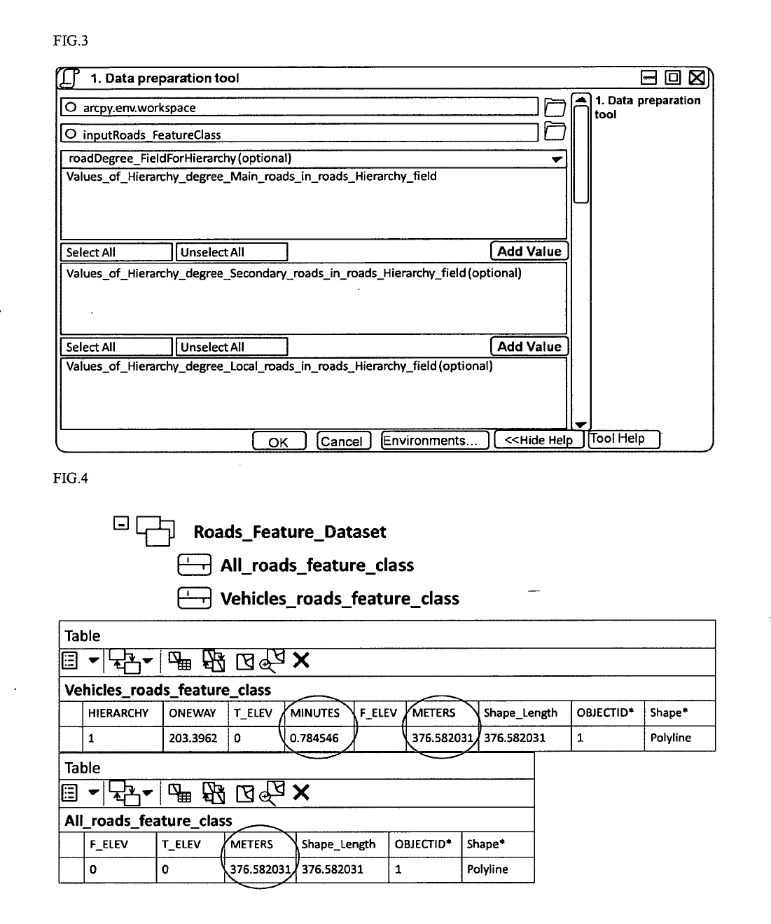

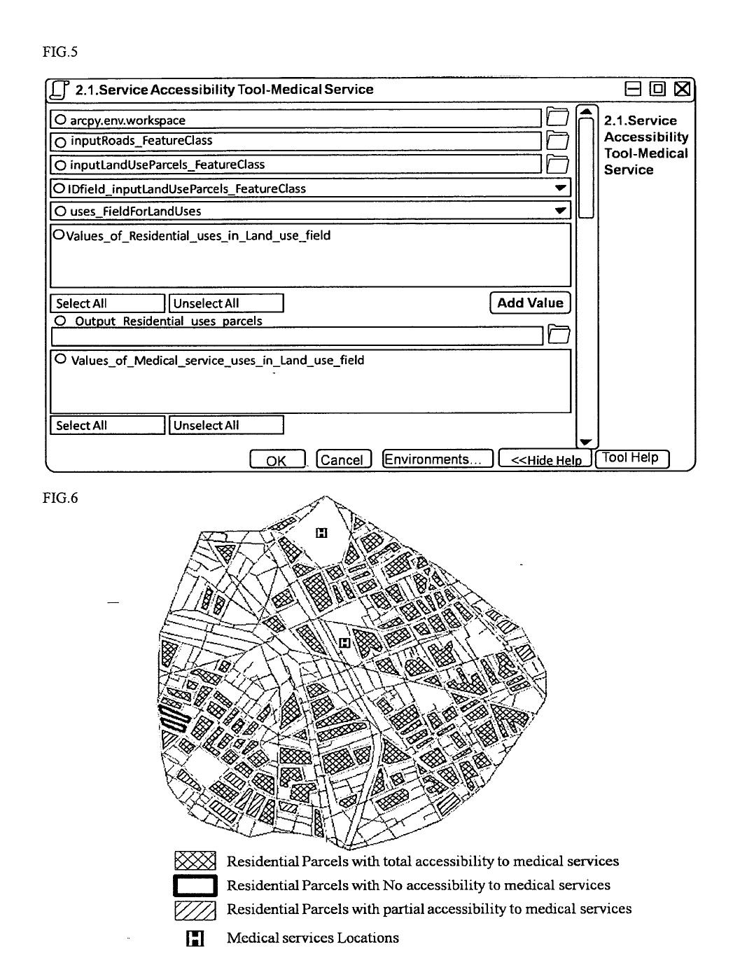

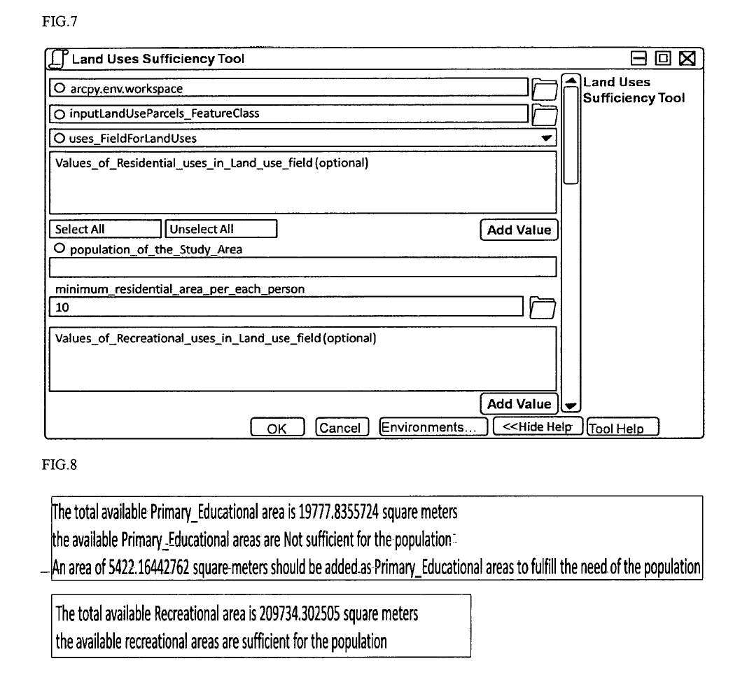

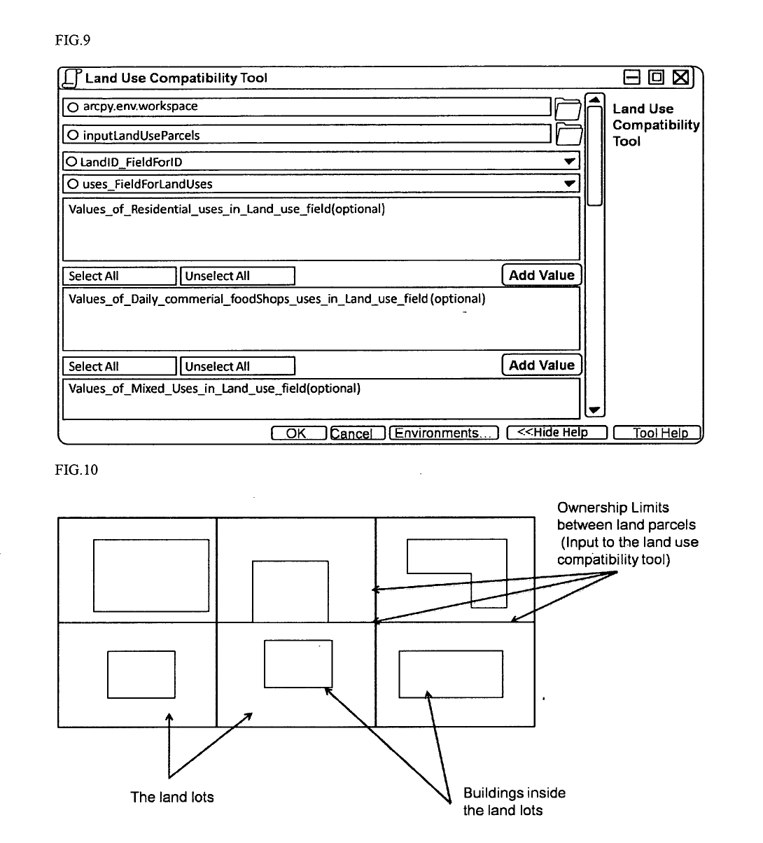

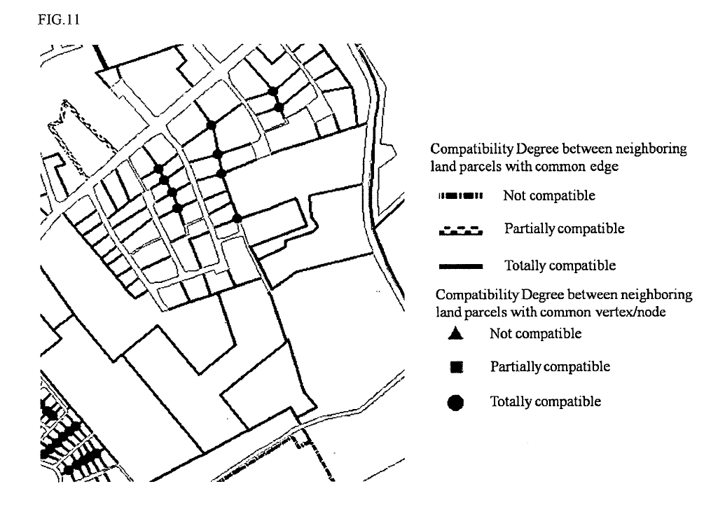

Tateosian L. (2015). Python for ArcGIS. Springer International Publishing Switzerland, North Carolina State University, USA.

German Services Standards:

Reference for Residential Uses:

Borchard, Klaus. (1974). Orientierungswerte für die städtebauliche Planung. Institut fuer Staedtebau und Wohnungswesen der Deurschen Akademie fuer Staedtebau und Landesplannung, Muenchen.

References for Other Uses:

AMINDE, HANS-GRAMMEL, URSULA-STIEHLE, ANNETTE. (2010). Infrastruktur und Zentrengliederung. book chapter in “Lehrbausteine Städtebau-Basiswissen für Entwurf und Planung”, Das Städtebau-Institut, Universität Stuttgart, Fakultät Architektur und Stadtplanung, Stuttgart. (pp. 105-124).

Schoening, Georg & Borchard, Klaus. (1992). Staedtebau im Uebergang zum 21.Jahrhundert, Karl Kraemer Verlag Stuttgart, Stuttgart.

1. A group of tools within a toolbox for assessing the sustainability attainment in the land-use structure of various urban spaces, including:
small urban areas, which are supposed to mainly having residential or mixed-residential land-uses and the minimum level from the daily-required services land-uses.

2. The group of tools according to claim 1 assess the sustainability attainment within the land-use structure of urban spaces in either current or planned state, through sub-groups, including:
the land-use sufficiency sub-group;
the services accessibility sub-group; and
the land-uses compatibility sub-group.

3. The group of tools according to claim 1 can be in several structures, including:
toolbar;
menu list;
a group of commands;
a software extension; and
plug-in.

4. The land-use sufficiency sub-group according to claim 2 assesses the economic aspect of sustainability in the land-use structure, including:
evaluating the sufficiency of the areas of various land-use types for the needs of the target users of urban spaces; and
the identification of the areas required for the fulfillment of the target users' needs from the land-uses types, that have shortage in their areas.

5. The services accessibility sub-group according to claim 2 assesses the social aspect of sustainability in the land-use structure, including:
evaluating the equity in accessibility to various services by the target users of urban spaces, based on the distance or the transfer time between various locations, or both, or other criterion.

6. Evaluating the equity in accessibility to various services according to claim 5 can be based on one criterion, or more than one criterion.

7. The land-uses compatibility sub-group according to claim 2 assesses the environmental aspect assessment by analyzing the compatibility between neighboring land-uses within the land-use structures of urban spaces.

8. The land-uses sufficiency sub-group according to claim 2 performs steps including:
entering each of the land-use layer, total number of the urban space's users, the number of definite categories from the urban space's users, (if available), (e.g. people in the elementary school age), and other inputs;
selecting by attribute (land-use value) for the first land-use type;
calculating the total area of the polygons of the first land-use type;
calculating the total required area according to the standard of the required area for each user (person) from the first land-use type;
calculating the shortage in the area of the first land-use type in case that the calculated area is less than the required area or equal zero;
selecting by attribute (land-use value) for the next land-use type in case that the calculated area is more than or equal the required area;
repeat the steps for checking the sufficiency of each land-use type for the target users; and
performing the output of the evaluation of the land-use sufficiency to clarify the available area from each land-use type and whether this area is sufficient or not, with the required area to be added to fulfill the users' needs, in case of the insufficiency.

9. The services accessibility sub-group according to claim 2 has various tools' categories, including:
the data preparation tool for preparing input roads network layer for the service accessibility evaluation;
tools for evaluating the accessibility by vehicles to emergency services;
tools for evaluating the accessibility by vehicles to non-emergency services;
tools for evaluating the accessibility by walking to essential services for residential areas; and
tools for evaluating the accessibility by walking to other services.

10. The data preparation tool according to claim 9 performs steps, including:
entering roads network layer and other inputs;
selecting by attribute (roads' type value) for the vehicles roads, (i.e. roads, that can be accessed by vehicles);
creating a line vector layer, (with the same coordinate system of the input roads network layer), for the vehicles roads;
creating another line vector layer for all the roads, (i.e. including pedestrians roads);
adding the fields or columns required for the network analysis process in both vector layers; and
adding values to the added fields or columns, (in appropriate data format), from the original roads network layer.

11. Any tool of the services accessibility tools according to claim 9 performs steps, including:
entering the land-use layer with the appropriate roads vector layer for the type of service under evaluation and other inputs;
selecting by attribute (land-use value) for the residential uses;
creating a new polygon vector layer for the residential parcels, (with the same coordinate system of the input land-use layer);
identifying the locations of the residential parcels and the parcels of the service under evaluation;
establishing paths or routes between the residential and the service's parcels based on definite criterion or criteria;
obtaining a line vector layer for the established routes or paths;
classifying the established routes or paths into some categories according to the selected criterion or criteria; and
applying the symbology on the residential parcels polygons vector layer according to the category of routes or paths connecting them with the service's parcels.

12. The land-uses compatibility sub-group according to claim 2 performs steps, including:
entering the land-use layer and other inputs;
creating new two vector layers for the outputs, (with the same coordinate system of the input land-use layer), one for the output edges with type line, and the other for the output nodes with type point;
adding a field or column regarding the compatibility degrees in each output vector layer;
identifying the neighboring polygons within the land-use layer with common edge(s);
selecting the first two neighboring polygons with common edge(s);
finding the line(s) of the intersection between the two selected polygons;
copy the line(s) of the intersection to the previously created vector layer for the output edges;
adding the compatibility value to field or column of the compatibility degrees, according to the land-use types of the original two polygons;
repeat the same steps till no other neighboring polygons by edge(s);
identifying the neighboring polygons within the land-use layer with common node (or vertex);
selecting the first two neighboring polygons with common node (or vertex);
finding the point (or vertex) of the intersection between the two selected polygons;
copy the point (or vertex) of the intersection to the previously created vector layer for the output nodes;
adding the compatibility value to field or column of the compatibility degrees, according to the land-use types of the original two polygons;
repeat the same steps till no other neighboring polygons by node (or vertex); and
applying symbology on each of the output edges and the output nodes vector layers, according to the added compatibility degrees values in them.

13. Assessing criteria used in the group of tools according to claim 1, including:
criteria for the land-use sufficiency evaluation, which are the minimum required area per each person from residential and daily-required services land-uses in the urban spaces;
criteria for the evaluation of the services accessibility; and
criteria for the land-use compatibility analysis, which are the land-use compatibility degrees between each two probable land-uses types, from various land-uses categories, which may exist in urban spaces, (including polluting activities and rural land-uses).

14. The criteria for the evaluation of the services accessibility according to claim 13, including:
the ideal and maximum time for the transfer of emergency vehicles from the emergency services to various land-uses; and
the standard and maximum distance for the transfer by walking from the residential parcels to the daily-required services.

15. The scope of the assessing criteria used in the group of tools according to claim 1 can be expanded to include further criteria, including:
the minimum required area per each person from various land-use types in the urban spaces;
the ideal and maximum time for the transfer by vehicles among various land-uses;
the standard and maximum distance for the transfer by vehicles among various land-uses;
the standard and maximum distance for the transfer by walking among various land-uses; and
the standard and maximum time for the transfer by walking among various land-uses.

16. The tools within the services accessibility sub-group according to claim 2 can be combined in the future to be one tool with several uses.

17. The services accessibility sub-group according to claim 2 can be upgraded to do several functions, including:
dealing with complicated roads networks for the large cities with several types of roads networks or transport modes, (e.g. a tram network, and under-ground network);
identifying the most appropriate service location(s) to be more accessible by a larger number of target users; and
assessing the accessibility between any two land-uses types, (e.g. commercial and storage land-uses).

18. The land-uses compatibility sub-group according to claim 2 can be upgraded to do several functions, including:
suggesting the change of the land-use type of any land parcel from inappropriate type to other appropriate type; and
assessing the land-uses compatibility among unattached land parcels.

19. The group of tools according to claim 1 can be upgraded to have the ability to automatically converting any coordinate system to projected coordinate system.

20. The group of tools according to claim 1 can be upgraded to deal with rural spaces.
